(19) United States
(12) Patent Application Publication
(10) Pub. No.: US 2025/0010220 A1
(43) Pub. Date: Jan. 9, 2025

(54) MIRROR ILLUSION SYSTEMS AND METHODS

(71) Applicant: Universal City Studios LLC, Universal City, CA (US)

(72) Inventors: Akiva Meir Krauthamer, Ocoee, FL (US); Timothy Fitzgerald Garnier, Orlando, FL (US); Aaron Chandler Jeromin, Winter Garden, FL (US); Eric Ross Boxer, Clermont, FL (US)

(21) Appl. No.: 18/440,569

(22) Filed: Feb. 13, 2024

Related U.S. Application Data
(60) Provisional application No. 63/525,271, filed on Jul. 6, 2023.

(51) Int. Cl. A63J 21/00; G02B 26/08; G02B 27/00

(52) U.S. Cl. CPC A63J 21/00; G02B 26/0816; G02B 27/0093

(57) ABSTRACT

A show effect system may include a first mirror coupled to a first actuator and mounted to a wall, a second mirror coupled to a second actuator and mounted to the wall adjacent to the first mirror, and a sensor configured to monitor a viewing area for observing the first mirror and the second mirror, wherein the sensor is configured provide sensor data related to a guest within the viewing area. The show effect system may also include a controller communicatively coupled to the first actuator, the second actuator, and the sensor. The controller may determine the guest is in a location within the viewing area based on the sensor data and instruct the first actuator to adjust a position or an orientation of the first mirror to remove the location from a reflection of the first mirror.

### CROSS-REFERENCE TO RELATED APPLICATION

This application claims priority to U.S. Provisional Application No. 63/525,271, entitled “MIRROR ILLUSION SYSTEMS AND METHODS,” filed Jul. 6, 2023, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Special effects can be used throughout amusement parks and other entertainment venues to help immerse guests in the experience of a ride or attraction. Immersive environments may include three-dimensional (3D) props and set pieces, robotic or mechanical elements, and/or display surfaces that present media. For example, amusement parks may provide a show effect for guests. The show effect may include a visual illusion of the guest disappearing, such as a reflection of the guest disappearing. The show effect may enable the amusement park to provide creative methods of entertaining guests, such as presenting the illusion in a convincing manner.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a show effect system may include a first mirror coupled to a first actuator and mounted to a wall, a second mirror coupled to a second actuator and mounted adjacent to the first mirror, and a sensor configured to provide sensor data related to a guest within the viewing area. The show effect system may also include a controller communicatively coupled to the first actuator, the second actuator, and the sensor. The controller may determine whether the guest is within the viewing area based on the sensor data and may instruct the first actuator to adjust a position or an orientation of the first mirror to alter a reflection of the mirror as viewed by the guest.

In an embodiment, a non-transitory computer-readable medium, may include instructions that, when executed by one or more processors, cause the one or more processors to receive sensor data from a sensor monitoring guest activity, determine a position of a guest relative to a show effect system based on the sensor data, and instruct at least one actuator of the show effect system to adjust a position or an orientation of at least one mirror of the show effect system to alter a reflection of the mirror as viewed by the guest to exclude a reflection of the guest on at least one mirror.

In an embodiment, an attraction system for an attraction may include a first mirror, a second mirror, and one or more actuators configured to adjust a position and/or orientation of the first mirror, the second mirror, or both. The attraction system may also include one or more sensors that track a position of a guest within the attraction system and a controller that may receive, from the one or more sensors, sensor data indicative of the position of the guest, determine a target angle between the first mirror and the second mirror to exclude the reflection of the guest from a reflection of a first mirror and/or the second mirror based on the position of the guest, and instruct the one or more actuators to adjust the positioning and/or the orientation of the first mirror, the second mirror, or both based on the target angle.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an attraction system of an amusement park, in accordance with an aspect of the present disclosure;

FIG. 2 is a schematic front elevational view of the attraction system of FIG. 1 including a show effect system, in accordance with an aspect of the present disclosure;

FIG. 3 is a schematic overhead view of the attraction system of FIG. 1 including the show effect system, in accordance with an aspect of the present disclosure;

FIG. 4 is a front schematic view of the attraction system of FIG. 1 including the show effect system in accordance with an aspect of the present disclosure;

FIG. 5 is a schematic front elevational view of the attraction system of FIG. 1 including the show effect system, in accordance with an aspect of the present disclosure;

FIG. 6 is a schematic side elevational view of the attraction system of FIG. 1 including the show effect system, in accordance with an aspect of the present disclosure; and

FIG. 7 is a flowchart of an example method or process for operating the attraction system of FIG. 1, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to providing show effects for entertainment purposes. For example, present embodiments may be employed to entertain guests in an amusement park. The amusement park may include a variety of features, such as rides (e.g., a roller coaster), theatrical shows, set designs, performers, and/or decoration elements, to entertain guests. Show effects may be used to supplement or complement the features, such as to provide the guests with a more immersive and/or unique experience. For example, the show effects may be presented along with real world objects to provide an interactive experience for the guests.

The attraction system may include a show effect system configured to present a show effect, such as a disappearing illusion, that creates an immersive and/or unique experience for the guest. To present the show effect, the show effect system may include two mirrors parallel to each other on a first wall. As would be understood by one of ordinary skill in the art, the use of the term “parallel” references a general orientation and is not a strictly mathematical use of the term. Thus, one of ordinary skill in the art would understand that the mirrors are generally aligned in an orientation that is substantially parallel, as would be judged by a casual observer. The show effect system may also include one or more objects on a second wall that may be adjacent to or opposite the first wall. In an embodiment, the first wall may be a first wall portion and the second wall may be a second wall portion of the same curved wall. A field of view reflected by the mirrors may include the second wall and the one or more objects. In addition, a guest may approach the show effect system and view a reflection of themselves and/or the one or more objects in the two mirrors.

The show effect system may adjust a configuration of mirrors such that the guest may view the reflection of the one or more objects but no longer view the reflection of themself in the mirrors. For example, each of the mirrors may be coupled to one or more actuators that adjust the position and/or orientation of the mirrors. Adjusting the position or the orientation of the mirrors may adjust the field of view reflected by the mirrors. When the reflection excludes the guest), it may appear to the viewers as though they have disappeared. In addition, the disappearing effect may be presented along with a distraction, such as a loud sound, a flash of light, or another distraction to cause the guest to briefly look away from the mirrors. Accordingly, embodiments of the present disclosure are directed to a show effect system that provides a realistic illusion effect. In some embodiments, the two mirrors may be replaced with multiple mirrors, a single mirror with a flexible joint, or another arrangement of one or more mirrors that allows for position or orientation adjustments to achieve the desired change in the field of view reflected by the one or more mirrors as viewed by the guest. Reference to a field of view in the present disclosure indicates a reflection of the mirror (i.e., imagery, such as a scene, reflected by the mirror) as perceived by the guest. Reference to a reflection of a mirror corresponds to what imagery is being reflected by the mirror such that it is viewable by the guest from a particular guest location. For example, the guest (at a particular guest location) may perceive a first view reflected from the mirrors (i.e., in respective reflections of the mirrors) when the mirrors are in a first configuration (e.g., positions and/or orientations) and perceive a second view different from the first view as reflected from the mirrors when the mirrors are in a second configuration different from the first configuration.

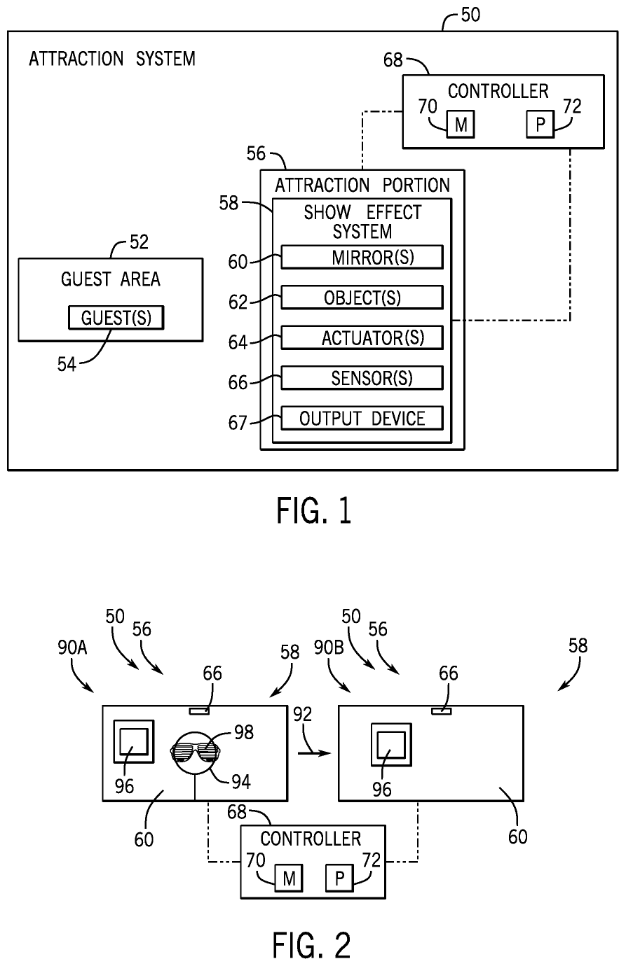

With the foregoing in mind, FIG. 1 is a schematic diagram of an embodiment of an attraction system 50 of an amusement park in accordance with the present disclosure. As an example, the guest area 52 may include a path (e.g., a walkway, a queue, a line) through which guest(s) 54 may navigate. As another example, the guest area 52 may include a space (e.g., a seating area) where the guest(s) 54 may be positioned to view a performance. As a further example, the guest area 52 may include a ride vehicle that may move and carry the guest(s) 54 throughout the attraction system 50.

Furthermore, the attraction system 50 may include an attraction portion 56 that may provide entertainment to the guest(s) 54. The attraction portion 56 may include a ride (e.g., a dark ride), a haunted house, an escape room, a theater, a maze, and the like. The attraction portion 56 may include the show effect system 58 that provides a show effect for the guest(s) 54. For example, the attraction portion 56 may be a haunted house attraction that includes pathways for the guest(s) 54 to traverse through the attraction portion 56. In addition, the attraction portion 56 may include a pathway leading the guest(s) 54 to the show effect system 58. In certain instances, the attraction portion 56 may include a marker or an indicator for positioning the guest(s) 54 relative to the show effect system 58, to provide a visually realistic illusion to the guest(s) 54. For example, in a first configuration, the guest(s) 54 may be positioned to view a reflection from the show effect system 58 including a reflection of the guest(s) 54 and surrounding walls of the attraction portion 56. Then, in a second configuration, the guest(s) 54 may no longer view their reflection in the show effect system 58 but may continue to view a reflection of the surrounding walls. In this way, the show effect system 58 may provide a realistic, disappearing illusion to the guest(s) 54.

In another example, the attraction portion 56 may be a theater, and the guest(s) 54 may participate in a close proximity show with one or more actor(s). For example, the guest(s) 54 may perceive the actor(s) to be playing the role of a fictional character (e.g., magician, vampire, ghost) based on the behavior of the actor(s) and/or interactions between the actor(s) and the show effect system 58. That is, the guest(s) 54 may not perceive a reflection of the actor(s) in the show effect system 58, which may be indicative of a vampire. In certain instances, the actor(s) may interact with the guest(s) 54 and, subsequently, the guest(s) 54 may not view their reflection in the show effect system 58, which may indicate that the guest(s) 54 transformed into the fictional character. As such, the show effect system 58 may provide an interactive experience for the guest(s) 54. Although the illustrated show effect system 58 is located within the attraction portion 56, in an embodiment, the show effect system 58 may be located within the guest area 52.

Returning to the show effect system 58, the show effect system 58 may provide a show effect, such as a disappearing illusion, to the guests(s) 54. To this end, the show effect system 58 may include one or more mirror(s) 60, one or more object(s) 62, one or more actuator(s) 64, one or more sensor(s) 66, and/or an output device 67. The one or more mirror(s) 60 may be mounted to a first wall of the attraction portion 56 and may reflect light within the attraction portion 56. For example, each of the one or more mirror(s) 60 may reflect light in a particular direction. What the mirror reflects and the guest(s) 54 view may be based on a position and/or an orientation of the mirror(s) 60 within the attraction portion 56. To this end, the one or more mirror(s) 60 may be made of glass, plastic, a polymeric material, a semi-reflective material, a reflective material, and the like. For example, the guest(s) 54 may be positioned in front of the one or more mirror(s) 60 such that the guest(s) 54 may view their reflection and the reflection of one or more walls adjacent and/or opposite to the first wall. In addition, the guest(s) 54 may view the reflection of other guest(s) 54 positioned in front of the one or more mirror(s) 60.

The show effect system 58 may also include the one or more object(s) 62 positioned on a second wall of the attraction portion 56. The second wall may be adjacent to the first wall and within the field of view of the one or more mirror(s) 60. As such, the one or more object(s) 62 mounted on the second wall may be reflected by the one or more mirror(s) 60 and visible to the guest(s) 54. In another example, the second wall may be directly opposite the first wall, such that the guest(s) 54 may view a reflection of the object(s) 62 via the one or more mirror(s) 60. The one or more object(s) 62 may include a display (e.g., liquid crystal display (LCD), light emitting diode (LED) display, organic light emitting diode (OLED) display, micro-LED, a projector), projector, screen, a light source, a painting, decorations, show props, animated figures, and the like. For example, the one or more object(s) 62 may be a digital display that receives image data and displays imagery. In another example, the one or more object(s) 62 may include show props such as a painting, a clock, a figurine, a book, and the like. In certain instances, the one or more object(s) 62 may be coupled to an actuator that adjusts a position and/or orientation of the one or more object(s) 62 to provide a realistic show effect to the guest(s) 54. This may be done to complement the effect caused by adjusting the mirror(s) 60. A similar adjustment could be made to images on the electronic display. For example, changing the field of view reflected by the mirror(s) 60 may cause reflected features (e.g., object(s) 62 or display imagery) to appear to move apart or away from a center of the reflected scene. To offset this and enhance immersive characteristics of the show effect, the features may move together or towards the center of the reflected scene to offset the perceived moving apart caused by the change in the reflected field of view.

In addition, the one or more mirror(s) 60 may be respectively coupled to the one or more actuator(s) 64. The one or more actuator(s) 64 may adjusts a position and/or orientation of the one or more mirrors 60, respectively. The one or more actuator(s) 64 may adjust a position and/or orientation of the respective mirror 60 by rotating, orienting, and/or linearly translating each of the one or more mirror(s) 60 between a first position and a second position. In the first position, the one or more mirror(s) 60 may be flush against the first wall. In the second position, the one or more mirror(s) 60 may be angled with respect to the first wall, angled such that an angle is formed between two or more mirror(s) 60, and/or such that the position and/or orientation of the one or more mirror(s) 60 is adjusted. To this end, the one or more actuator(s) 64 may include a linear actuator, a cammed mechanical device, a pneumatic actuator, a rotary, and the like. In an example, the one or more actuator(s) 64 may use linear motion to adjust the position and/or the orientation of the one or more mirror(s) 60.

Additionally or alternatively, the one or more actuator(s) 64 may be respectively coupled to the one or more object(s) 62. For example, in the first position, the one or more object(s) 62 may be positioned on a first portion of the second wall. To provide a realistic show effect, the position and/or orientation of the one or more object(s)_62 may be adjusted based on the adjusted position and/or orientation of the one or more mirror(s) 60. For example, the one or more object(s) 62 may be moved in a horizontal direction to account for the adjusted position and/or orientation of the one or more mirror(s) 60. In another example, the one or more object(s) 62 may be rotated. As such, the one or more object(s) 62 may not have appeared to move to the guest(s) 54 during the show effect.

The show effect system 58 may also include the one or more sensor(s) 66 to determine guest attributes, such as movement of the guest(s) 54, facial features of the guest(s) 54, a position and/or orientation of the guest(s) relative to the show effect system 58, and the like. For example, the one or more sensor(s) 66 may be positioned to monitor guest activity associated with the guest(s) 54, such as movement of a body component (e.g., head, arms, legs) and/or a distance between the guest(s) 54 and the one or more mirror(s) 60. The one or more sensor(s) 66 may also determine an eye movement of the guest(s) 54, a line of sight of the guest(s) 54, a perspective of the guest(s) 54, and the like. To this end, the one or more sensor(s) 66 may include a camera (e.g., optical camera, three-dimensional (3D) camera, infrared (IR) camera, depth-based camera), a position sensor (e.g., sonar sensor, radar sensor, laser imaging, detection, and ranging (LIDAR) sensor), time of flight sensor, and the like. For example, the one or more sensor(s) 66 may generate video data of the guest(s) 54 (e.g., in the IR spectrum, which may not be visible to the guest(s) 54). In another example, the one or more sensor(s) 66 may track one or more attributes (e.g., facial features, height, eye level) of the guest(s) 54. In addition, the one or more sensor(s) 66 may determine a cone of sight of the guest(s) 54 when viewing the show effect system 58. In another example, the one or more sensor(s) 66 may include a proximity sensor to determine a position of the guest(s) 54 relative to the show effect system 58. Still in another example, the one or more sensor(s) 66 may include a computer vision system that tracks a longitudinal and lateral position of the guest(s) 54 relative to the show effect system 58.

The show effect system 58 may also include the output device 67. The output device 67 may provide visual effects and/or audio effects. To this end, the output device 67 may include a strobe light, an LED, an OLED, a flashlight, a speaker, smoke system, and the like. For example, the output device 67 may be a strobe light that provides a sudden flash of light that causes the guest(s) 54 to break their line of sight with the one or more mirror(s) 60. Additionally or alternatively, the flash of light may temporarily block the guest(s) 54 from viewing the one or more mirror(s) 60, thereby breaking the line of sight. In another example, the output device 67 may provide a loud sound to distract the guest(s) 54 from looking at the one or more mirror(s) 60. Additionally or alternatively, the actor(s) may create a distraction to divert the guest(s) 54 from viewing the one or more mirror(s) 60. For example, the actor(s) may approach the guest(s) 54, interact with the guest(s) 54, and the like.

The attraction system 50 may include or coordinate with a controller 68 (e.g., a control system, an automated controller, a programmable controller, an electronic controller, control circuitry, a cloud-computing system) configured to operate the show effect system 58 to provide the interactive experience to the guest(s) 54. For example, the controller 68 may be communicatively coupled (e.g., via one or more wires, via wireless communication (e.g., via transmitters, receivers, transceivers)) to the one or more object(s) 62, the one or more actuator(s) 64, the one or more sensor(s) 66, and/or the output device 67. The controller 68 may include a memory 70 (representative of one or more memories) and processing circuitry or a processor 72 (representative of one or more processors). The memory 70 may include volatile memory, such as random-access memory (RAM), and/or non-volatile memory, such as read-only memory (ROM), optical drives, hard disc drives, solid-state drives, or any other non-transitory computer-readable medium that includes instructions to operate the show effect system 58. The processor 72 may be configured to execute such instructions. For example, the processor 72 may include one or more application specific integrated circuit(s) (ASICs), one or more field programmable gate array(s) (FPGAs), one or more general purpose processor(s), or any combination thereof. In certain instances, the controller 68 may include one or more controller(s) that are communicatively coupled and may individually or collectively perform actions described herein. Additionally or alternatively, the controller 68 may include one or more processor(s) 72 and/or one or more memories 70 that may individually or collectively perform the actions described herein.

In an embodiment, the controller 68 may receive the sensor data from the one or more sensor(s) 66 and operate to determine a cone of sight of the guest(s) 54 and/or a position of the guest(s) 54 relative to the one or more mirror(s) 60, and transmit a control signal to the one or more actuator(s) 64 instruct generation of the show effect. For example, the controller 68 may receive sensor data from a proximity sensor and determine the position and/or orientation of the guest(s) 54 relative to the one or more mirror(s) 60. Based on the position and/or orientation of the guest(s) 54 along with established data on human visual capabilities, the controller 68 may determine a cone of sight of the guest(s) 54. In another example, the controller 68 may determine a number of guest(s) 54 interacting with (e.g., viewing) the one or more mirror(s) 60. In addition, the controller 68 may utilize image analysis techniques to determine guest attributes, such as facial features of the guest(s) 54 and/or an eye movement (e.g., blinks) of the guest(s) 54 and instruct generating of the show effect during a blink of the guest(s) 54.

To generate a realistic show effect for the guest(s) 54, the controller 68 may instruct the one or more actuator(s) 64 to adjust a position and/or orientation of the one or more object(s) 62. The guest(s) 54 may view a reflection of the one or more object(s) 62 when the one or more mirror(s) 60 are in the first position and the second position. For example, the position and/or orientation of the one or more object(s) 62 may be adjusted from a first position to a second position such that the reflection of the one or more object(s) 62 within the one or more mirror(s) 60 visually appears to the guest(s) 54 to have not moved. In certain instances, the one or more object(s) 62 may be a display (e.g., an electronic display system), and the controller 68 may generate and transmit image data to the display to update the displayed image content. For example, the updated image content may be similar image content shifted in one direction or rotated to appear as if the position and/or orientation of the one or more object(s) 62 changed.

While present embodiments may operate without a manufactured distraction, in certain embodiments, the controller 68 may instruct the output device 67 to provide a distraction to the guest(s) 54 and distract the guest(s) 54 from viewing the one or more mirror(s) 60. To this end, the controller 68 may instruct the output device 67 to generate a visual and/or audio output to divert the guest's attention from the one or more mirror(s) 60. While the guest's attention may be diverted from the one or more mirror(s) 60, the controller 68 may transmit instruct the one or more actuator(s) 64 to instruct adjustment of the position and/or orientation of the one or more mirror(s) 60. For example, the one or more actuator(s) 64 may transition the one or more mirror(s) 60 from the first position to the second position, thereby adjusting the reflection from the one or more mirror(s) 60 as viewed by the guest(s) 54. As such, the controller 68 may instruct generation of the show effect to create an immersive environment for the guest(s) 54.

The controller 68 may then instruct the one or more actuator(s) 64 to transition the one or more mirror(s) 60 from the second position back to the first position to reset the show effect system 58. For example, the one or more actuator(s) 64 may adjust the position and/or the orientation of the one or more mirror(s) 60 to be oriented in parallel with each other. Additionally or alternatively, the controller 68 may instruct to the one or more actuator(s) 64 to transition the one or more object(s) 62 from the second position to the first position. In this way, the controller 68 may reset the show effect system 58 to prepare for subsequent guest interactions.

FIG. 2 is a schematic front perspective view of the attraction system 50 including the show effect system 58 in accordance with an embodiment of the present disclosure. In particular, the show effect system 58 may transition from a first configuration 90A to a second configuration 90B as represented by the arrow 92. By way of example, the guest may approach the show effect system 58 and view their reflection (e.g., first reflected element 94) in the first configuration 90A and the guest may not view their reflection in the second configuration 90B. As illustrated, the show effect system 58 includes one mirror 60 that transitions between the first configuration 90A and the second configuration 90B and one sensor 66 positioned to monitor guest attributes. With respect to the guest's perspective, the mirror 60 appears to not have changed from the first configuration 90A to the second configuration 90B. As further described herein, the position and/or orientation of the mirror 90 is adjusted to provide the show effect. To this end, the mirror 60 may include a hinge that provides rotation of a first portion of the mirror 60 and a second portion of the mirror 60 and the mirror 60 may be coupled to one or more actuator(s) that may adjust a position and/or orientation of the first portion, the second portion, or both. The sensor 66 may monitor the position and/or orientation of the guest relative to the show effect system 58, facial features of the guest, eye movement of the guest, and the like. For example, the sensor 66 may determine if the guest may be within a designated area adjacent to the show effect system 58. If the guest is not within the designated area, then the show effect system 58 may not provide the show effect for the guest and remain in the first configuration 90A. If the guest is within the designated area, then the show effect system 58 may instruct generation of the show effect for the guest by transitioning from the first configuration 90A to the second configuration 90B. Such a transition may be activated by the show effect system 58 upon detection of a guest's eyes blinking or based on other triggers (e.g., visual or audio diversion).

In the first configuration 90A, the guest may be positioned in front of the mirror 60 and view a reflection that may be a first reflected element 94 (e.g., a reflection of themselves) and a second reflected element 96 (e.g., a reflection of the one or more object(s) in a background area). As illustrated, the first reflected element 94 may include a reflection of the guest and the second reflected element 96 may include a reflection of one or more object(s) mounted on the second wall of the attraction portion. The reflection may also include portions of the second wall, one or more additional guest(s) within the attraction portion, one or more actor(s) within the attraction portion, and the like.

In certain embodiments, the show effect system 58 may provide a diversion that may temporarily break a line of sight between the guest and the mirror 60. For example, the controller may instruct the output device to generate a visual diversion and/or an audio diversion. The visual diversion may be a sudden burst of light reflected by the mirrors 60 to break a line of sight between the guest and the mirrors 60. In an instance, the audio diversion may be an explosion sound or a loud noise that causes the guest to turn away from the show effect system 58. Still in another example, the diversion may include both the visual diversion and the audio diversion. The diversion may include both the flash of light and the loud noise, which may cause the guest to break contact with the show effect system 58.

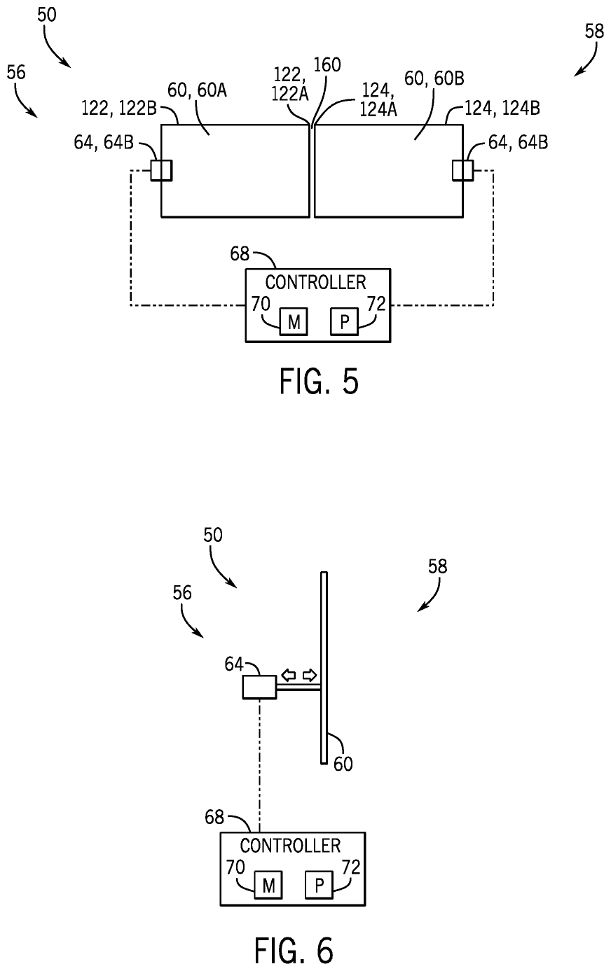

In certain instances, the show effect system 58 may determine a blinking pattern of the guest and transition from the first configuration 90A to the second configuration 90B during a blink. Transitioning based on a detected blink may be done with or without a diversion. In an embodiment, the guest may wear shutter glasses 98 that periodically block the guest's perspective. For example, the shutter glasses may include one or more shutters (e.g., louvers) that open and close to provide an interactive experience for the guest. The shutter glasses 98 may be communicatively coupled to the controller 68 such that a timing of operation of the shutter glasses 98 may be synchronized to a timing of operation of the actuator 64. For example, when the shutter glasses 98 close, the controller 68 may instruct the one or more actuator(s) to adjust the position and/or orientation of a first portion of the mirror 60 and the second portion of the mirror 60. As such, the guest may view the show effect or a realistic disappearing illusion effect. In certain instances, multiple guest(s) may simultaneously interact with the show effect system 58. Each guest may wear a pair of shutter glasses to view the show effect. For example, the shutter glasses 98 may be synchronized such that the shutter glasses close together and the one or more actuator(s) adjust the position and/or orientation of the mirror 60, respectively. Although in the illustrated embodiment, the mirror 60 is a single flexible mirror or components of a hinged mirror and the actuator may be a single actuator that bends the flexible mirror or causes bending or rotation about a hinge between mirror components, in other embodiments, the mirror 60 may include multiple mirrors, such as described with respect to FIGS. 4 and 5.

In the second configuration 90B, the guest(s) may remain positioned in front of the mirror 60, but may not view the first reflected element 94 (e.g., a reflection of the guest). The position and/or orientation of the mirror 60 may be adjusted, which may adjust the reflection from the mirror 60 as viewed by the guest. For example, the first reflected element 94 may disappear with respect to the guest's perspective. In addition, due to repositioning of the second reflected element 96 based on changes to the position and/or orientation of mirrors 60, the second reflected element 96 may appear to remain in the same position with respect to the guest's perspective. To this end, the one or more actuator(s) may adjust the position and/or orientation of the one or more object(s) such that the second reflected element 96 may be perceived by the guest to have not moved. In other embodiments, the one or more object(s) may be a display and updated image data may be used to create a similar effect. In this way, the guest(s) may perceive their reflection to vanish but the reflection of the attraction portion to be unchanged between the first configuration 90A and the second configuration 90B. As such, the show effect system 58 may provide an interactive and/or immersive experience for the guest.

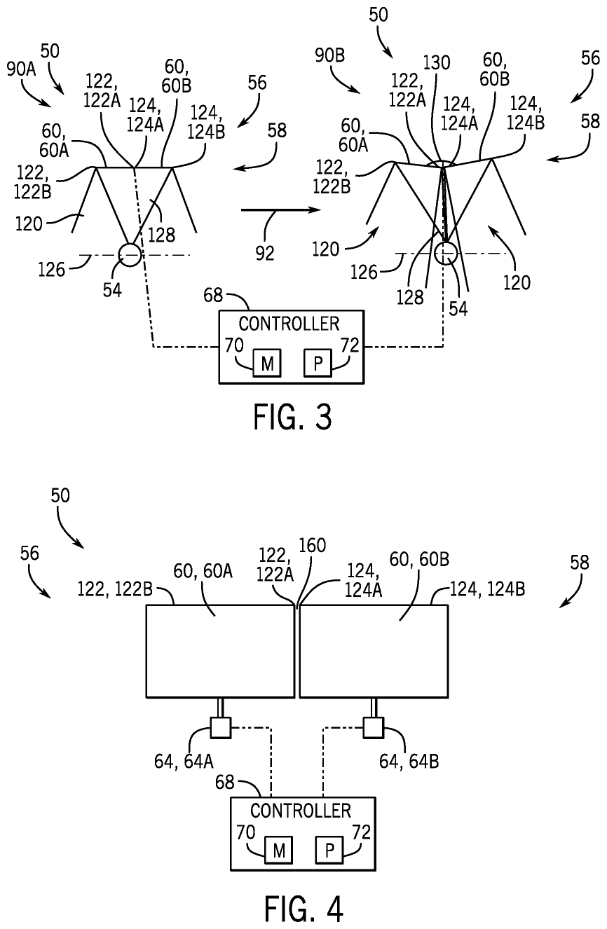

FIG. 3 is an overhead schematic view of the attraction system 50 in accordance with an embodiment of the present disclosure. In particular, the show effect system 58 may transition from the first configuration 90A to the second configuration 90B as represented by the arrow 92. As illustrated, the show effect system 58 includes two mirrors 60 (referred to individually as a first mirror 60, 60A and a second mirror 60, 60B). In the first configuration 90A, the mirrors 60 may be parallel and the guest 54 may view their reflection and reflections of the one or more object(s). In the second configuration 90B, the position and/or orientation of the two mirrors 60 may be adjusted such that the guest 54 may not view their reflection and continue to view the reflection of the one or more object(s). In other embodiments, the two mirrors 60 may be adjusted such that the guest 54 views their reflection but may not view the reflection of the one or more object(s). Indeed, the reflection from the mirrors 60 as viewed by the guest 54 may be adjusted as desired based on the position and/or the orientation of each of the mirrors 60.

Returning to the first configuration 90A, the first mirror 60, 60A and the second mirror 60B may be mounted in parallel on the first wall of the attraction portion. For example, an edge 122 of the first mirror 60, 60A may be adjacent to an edge 124 of the second mirror 60, 60B. Although not illustrated, a seam between the first mirror 60, 60A and second mirror 60, 60B may be disguised by flexible and/or reflective material that visually appears similar to the mirrors 60. In other embodiments, the seam may be disguised by show props, such as a cobweb, fake blood, glitter, cards, and the like. As such, the guest 54 may view the two mirrors as one continuous mirror. The first mirror 60, 60A and the second mirror 60, 60B may reflect light within the attraction portion 56 to create the reflection viewed by the guest 54. For example, the first mirror 60, 60A and the second mirror 60, 60B may each include a reflection 120 viewed by the guest 54, which may be based on the position and/or the orientation of the respective mirror 60. The reflection 120 may be an area of the attraction portion visible from the perspective of the guest 54 as reflected from the two mirrors 60. As illustrated, the reflection 120 may extend from a second edge 122, 122B of the first mirror 60, 60A and a second edge 124, 124B of the second mirror 60, 60B. That is, the reflection 120 may include the guest 54.

The show effect system 58 may include a marker 126 for positioning the guest(s) 54 relative to the mirrors 60 and positioning at the marker may serve as a trigger for initiating certain system operations. For example, the marker 126 may be a line on the floor of the attraction portion 56 that serves as a guide for where the guest 54 should stand or sit. The guest 54 may be positioned at or around the marker 126 to view the show effect. For example, the guest 54 may have an understood or estimated cone of sight 128 when viewing the first mirror 60, 60A and the second mirror 60, 60B. The cone of sight 128 may be a portion of the mirrors 60 where the guest 54 may have an unobstructed view. As illustrated, the guest 54 may have a cone of sight 128 extending from the second edge 122, 122B of the first mirror 60, 60A to the second edge 124, 124B of the second mirror 60, 60B. That is, the cone of sight 128 may cover the reflections from the first mirror 60, 60A and the second mirror 60, 60B. In the first configuration 90A, the guest 54 may view their reflection in the mirrors 60.

In the second configuration 90B, the position and/or orientation of the first mirror 60, 60A and/or the second mirror 60, 60B may be adjusted, thereby changing the reflection 120 of the mirrors 60 as viewed by the guest to provide the show effect, such as a disappearing illusion effect. For example, the first mirror 60, 60A and the second mirror 60, 60B may be oriented at an angle 130 with respect to each other and with the first wall. As illustrated, the second edge 122, 122B of the first mirror 60, 60A is positioned at an angle adjacent to the first wall and the second edge 124, 124B of the second mirror 60, 60B is positioned at an angle adjacent to the first wall. As such, the angle 130 between the first mirror 60, 60A and the second mirror, 60, 60B is formed. A size of the angle 130 utilized to achieve the illusion in the second configuration 90B may depend on the position and/or orientation of the guest 54 relative to mirrors 60. The angle 130 between the two mirrors 60 may decrease as the distance between the guest(s) 54 and the mirrors 60 increases. For example, the guest 54 may be positioned 10 to 15 feet away from the mirrors 60 and the angle 130 may be decreased by 10 degrees (e.g., from 180 degrees or the parallel orientation). In another example, the guest 54 may be positioned 1 to 5 feet away from the mirrors 60 and the angle 130 may be decreased by 25 degrees.

The adjustment may cause the reflection 120 of the first mirror 60, 60A and/or the second mirror 60, 60B to be shifted in a direction opposite to the position of the guest 54. As illustrated, the reflection 120 of the first mirror 60, 60A may be shifted to the left with respect to the guest's perspective and the reflection 120 of the second mirror 60, 60B may be shifted to the right with respect to the guest's perspective. As such, the reflection 120 of the first mirror 60, 60A and the second mirror 60, 60B may not include the guest 54.

Although the illustrated example includes adjusting the position and/or orientation of both the first mirror 60, 60A and the second mirror 60, 60B, the show effect system 58 may adjust the position and/or orientation of either the first mirror 60, 60A or the second mirror 60, 60B. For example, the guest 54 may stand at an edge of the first mirror 60, 60A. Based on the position and/or the orientation of the guest 54, the show effect system 58 may adjust the position and/or orientation of the first mirror 60, 60A such that the field of view 120 may not include the guest 54. In addition, the show effect system 58 may include more than two mirrors 60. For example, the show effect system 58 may include 3 or more, 4 or more, 5 or more, 6 or more mirrors, and so on to provide the show effect.

FIG. 4 is a front schematic view of the attraction system 50 in accordance with an embodiment of the present disclosure. As illustrated, the show effect system 58 includes the mirror 60 (referred to individually as a first mirror 60, 60A and a second mirror 60, 60B) coupled to the actuator 64 (referred to individually as a first actuator 64, 64A and a second actuator 64, 64B). The mirror 60 may visually appear to the guest as one continuous mirror, but the mirror 60 may be formed by the first mirror 60, 60A and the second mirror 60, 60B coupled by a hinge 160. The hinge 160 may provide a rotational axis for the one or more mirror(s) 60 to pivot about. As illustrated, the hinge 160 may be coupled along the first edge 122, 122A of the first mirror 60, 60A and the first edge 124, 124A of the second mirror 60, 60B. As such, the first mirror 60, 60A may pivot about the hinge 160 in a first direction and the second mirror 60, 60B may pivot about the hinge 160 in a second direction that may be opposite the first direction. In this way, the angle (e.g., the angle 130 described with respect to FIG. 3) between the first mirror 60, 60A and the second mirror 60, 60B may decrease and the field of view 120 of each mirror 60 may be adjusted to provide the show effect. In certain instances, the second edge 122, 122B of the first mirror 60, 60A and/or the second edge 124, 124B of the second mirror 60, 60B may be rotatably coupled to the first wall of the attraction portion 56.

In certain instances, the hinge 160 may be disguised and/or hidden from the guest's perspective by a polymer film, lighting effects, and decorations, such as fake cobwebs, imitation blood, strings of light, yarn, fabric, and so on. For example, a polyester film with similar visual properties as the mirrors 60 may hide the hinge 160 between the first mirror 60, 60A and the second mirror 60, 60B from the guest's perspective. In another example, foliage may be used to disguise the hinge 160. In addition, lighting within the attraction portion 56 may be dim to hide the hinge 160. As such, the guest may view the first mirror 60, 60A and the second mirror 60, 60B as one continuous mirror. In certain embodiments, the show effect system 58 may include multiple mirrors to provide the show effect. As such, hinges between each of the mirrors may be disguised from the guest's perspective using the polyester film, the decorations, the light effects, and the like.

To adjust the position and/or orientation of the first mirror 60, 60A and/or the second mirror 60, 60B, each of the mirrors 60 may be coupled to a respective actuator 64. By way of example, a first actuator 64, 64A may be coupled to an edge of the first mirror 60, 60A that may be adjacent to the hinge 160 and a second actuator 64, 64B may be coupled to an edge of the second mirror 60, 60B that may be adjacent to the hinge 160. The first actuator 64, 64A and/or the second actuator 64, 64B may use linear motion to move the hinge 160 towards the guest(s) 54. For example, the controller 68 may instruct the first actuator 64, 64A, to adjust the position and/or orientation of the first mirror 60, 60A by pushing the first edge 122, 122A towards the guest(s) 54 and/or away from the first wall. The controller 68 may determine a target angle between the first mirror 60, 60A and the second mirror 60, 60B and instruct the first actuator 64, 64A to adjust the position and/or orientation of the first edge 122, 122A based on the target angle. In addition, the controller 68 may instruct the second actuator 64, 64B to adjust the position and/or orientation of the second mirror 60, 60B by pushing or pulling the first edge 124, 124A of the second mirror 60, 60B. The controller 68 may concurrently instruct the first actuator 64, 64A and the second actuator 64, 64B to adjust the position and/or orientation of the first mirror 60, 60A and the second mirror 60, 60B, respectively. Further still, the actuator 64 may be a single actuator that operates the hinge 160 to transition between angles of opposing hinge coupling portions.

FIG. 5 is a schematic front elevational view of the attraction system 50 in accordance with an embodiment of the present disclosure. The attraction system 50 is substantially similar to the schematic diagram of the attraction system 50 in FIG. 4 except that the actuator 64 (referred to individually as a first actuator 64, 64A and a second actuator 64, 64B) is coupled to an edge of the first mirror 60, 60A and/or the second mirror 60, 60B opposite the hinge 160. As illustrated, the first actuator 64, 64A may be coupled to the second edge 122, 122B of the first mirror 60, 60A and the second actuator 64, 64B may be coupled to the second edge 124, 124B of the second mirror 60, 60B. The actuator 64 may be a rotary that adjusts the position and/or orientation of the second edge 122, 122B of the first mirror 60, 60A and/or the second edge 124, 124B of the second mirror 60, 60B, respectively.

FIG. 6 is a side schematic view of the attraction system 50 in accordance with an embodiment of the present disclosure. For example, the show effect system 58 may include the mirror 60 (which may be the first mirror 60, 60A and/or second mirror 60, 60B described with respect to FIGS. 2-6) coupled to the actuator 64 (which may be the first actuator 64, 64A and/or the second actuator 64, 64B). As discussed herein, the actuator 64 may be coupled to an edge of the mirror 60. In certain instances, the actuator 64 may be coupled to a surface of the mirror 60, such as a surface oriented towards the first wall of the attraction portion 56.

As illustrated, the actuator 64 may use linear motion to adjust the position and/or orientation of the mirror 60, such as from the first position associated with the first configuration to the second position associated with the second configuration, or vice versa. For example, the actuator 64 may push the edge of the mirror 60 away from the first wall (e.g., a first position) and/or pull the edge of the mirror 60 towards the first wall (e.g., a second position). In other instances, the actuator 64 may use rotational movement to adjust the position and/or orientation of the mirror 60, such as between the first position and the second position. That is, the actuator 64 may be coupled to the surface of the mirror 60 and rotate the mirror 60 to a target angle and/or target position. As such, the show effect system 58 may provide the show effect for the guests.

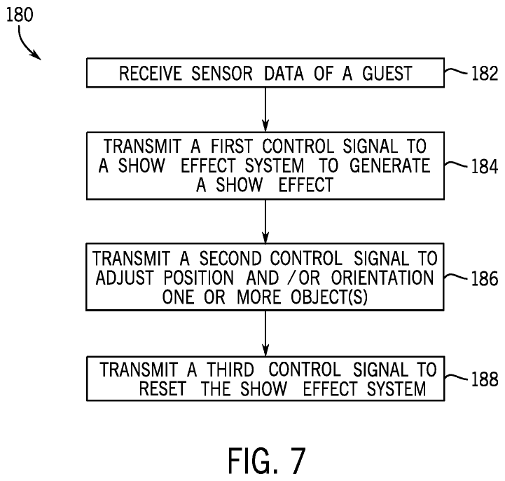

FIG. 7 is a flowchart of an example method 180 for operating the attraction system to generate the show effect in accordance with an embodiment of the present disclosure. Any suitable device (e.g., the processor 72 of the controller 68 illustrated in FIGS. 1-6 in coordination with other system components) may perform the respective methods. In an embodiment, each method may be implemented by executing instructions stored in a tangible, non-transitory, computer-readable medium (e.g., the memory 70 of the controller 68 illustrated in FIGS. 1-6). For example, each method may be performed at least in part by one or more software component(s), one or more software application(s), and the like. While each method is described using operations in a specific sequence, additional operations may be performed, the described operations may be performed in different sequences than the sequence illustrated, and/or certain described operations may be skipped or not performed altogether.

At block 182, the controller may receive sensor data indicative of one or more characteristics of a guest. For example, a guest may approach the show effect system and view a reflection that may include a first reflected element and a second reflected element. The first reflected element may be a reflection of the guest and the second reflected element may be a reflection of the attraction portion, such as a second wall, one or more object(s), show props, one or more actor(s), and the like. For example, the controller may receive the sensor data and determine guest attributes. The guest attributes may include a position and/or orientation of the guest, a height of the guest, an eye level of the guest, facial features of the guest, and the like. Based on the sensor data, the controller may determine the position and/or orientation of the guest relative to one or more mirror(s). In an instance, the controller may determine the position of the guest based on one or more marker(s) on a floor of the attraction portion. For example, image data from a camera may be used to confirm that the guest is on or near one or more marker(s). In other instances, the controller may determine if the guest may be within a designated area of the show effect system. Still in another instance, the controller may determine a cone of sight of the guest (e.g., line of sight) to determine the position and/or orientation of the one or more mirror(s) of the show effect system. In an embodiment, the controller may determine a blinking pattern of the guests to determine a timing for providing the show effect.

At block 184, the controller may transmit a first control signal to a show effect system to generate a show effect. This may be done after proper positioning of the guest is confirmed (e.g., guest positioning on a mark is detected). The controller may instruct an actuator to adjust a position and/or orientation of the one or more mirror(s), thereby adjusting a reflection of the one or more mirror(s). As such, the guest may not view the first reflected element and view only the second reflected element. The show effect may be provided during a period of time when the guest breaks eye contact with the show effect system. In other words, the show effect may be provided when the line of sight between the guest and the one or more mirror(s) is broken. In an embodiment, such breaking of eye contact may be detected by monitoring eye blinks of the guest. That is, the show effect may be provided when the guest closes their eyes during a blink. In other embodiments, the controller may instruct an output device to provide a diversion to break eye contact of the guest with the one or more mirror(s). The output device may provide a visual diversion, an audio diversion, or both. As such, the guest may temporarily break eye contact with the one or more mirror(s). When the guest looks back at the one or more mirror(s), the guest may not view their reflection but the guest may view the reflection of the attraction portion, the one or more object(s), the one or more actor(s), and the like.

At block 186, the controller may transmit a second control signal to adjust a position and/or orientation of one or more object(s). For example, the controller may instruct an additional actuator to adjust the position and/or orientation of the one or more object(s). For example, the additional actuator may move the one or more object(s) towards a center of the attraction portion to account for the adjusted field of view of the one or more mirror(s). Because reflected features in the background may actually change position to accommodate the change in the field of view, they may seem to remain in place and even if the guest turns around the actual features will be present and visible. To this end, the additional actuator may include a mechanical slide that moves the one or more object(s) from a first position to a second position within the attraction portion. In an embodiment, the second wall of the attraction portion may be a display. As such, the controller may generate image data based on the adjusted field of view of the one or more mirror(s) and instruct the display to display the updated image content. In another embodiment, the second wall may be a screen and the controller may transmit updated image data to the projector to compensate for the adjusted reflection of the mirror as viewed by the guest. Still in another embodiment, the controller may transmit a signal to the output device to adjust the lighting of the second wall. As such, the reflection as viewed by the guest of the one or more object(s) and/or the second wall may not appear changed. In certain embodiments, the method 100 may skip block 186 and go straight to 188. For example, if the show effect system does not include the additional actuator, the one or more object(s), and so on.

At block 188, the controller may transmit a third control signal to reset the show effect system. For example, the show effect system may continuously receive guest throughput. After the guests leave the show effect system, the controller may instruct the actuator and/or the additional actuator to adjust the position and/or orientation of the one or more mirror(s) and/or the one or more object(s). The actuator may adjust the position of the one or more mirror(s) from the second position (e.g., angled orientation) to the first position (e.g., parallel orientation). Additionally or alternatively, the additional actuator may adjust the position of the one or more object(s) from the second position to the first position. As such, the show effect system may prepare to provide the show effect to subsequent guests, thereby creating an interactive and immersive experience.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform) ing (a function) . . . ” or “step for (perform) ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A show effect system comprising:
a first mirror coupled to a first actuator and mounted to a wall;
a second mirror coupled to a second actuator and mounted to the wall adjacent to the first mirror;
a sensor configured to monitor a viewing area from which a guest can observe the first mirror and the second mirror, wherein the sensor is configured to provide sensor data related to the guest within the viewing area; and
a controller communicatively coupled to the first actuator, the second actuator, and the sensor, wherein the controller is configured to:
determine the guest is in a location within the viewing area based on the sensor data; and
instruct the first actuator to adjust a position or an orientation of the first mirror to remove the location from a first reflection of the first mirror.

2. The show effect system of claim 1, wherein the controller is configured to:
instruct the second actuator to adjust a position or an orientation of the second mirror to remove the location from a second reflection of the second mirror.

3. The show effect system of claim 2, wherein the sensor is configured to monitor guest movement and the controller is configured to:
determine a target angle between the first mirror and the second mirror based on the location the guest is in;
instruct the first actuator to adjust the position or the orientation of the first mirror based on the target angle; and
instruct the second actuator to adjust the position or the orientation of the second mirror based on the target angle.

4. The show effect system of claim 2, wherein the first mirror and the second mirror are rotatably coupled by a hinge, and wherein the first actuator is coupled to an edge of the first mirror opposite the hinge and the second actuator is coupled to an edge of the second mirror opposite the hinge.

5. The show effect system of claim 4, wherein the first actuator is configured to adjust the position or the orientation of the first mirror in a first direction and the second actuator is configured to adjust the position or the orientation of the second mirror in a second direction opposite the first direction.

6. The show effect system of claim 1, comprising an object coupled to an additional actuator and mounted opposite the first mirror and the second mirror, wherein the controller is configured to:
instruct the additional actuator to adjust a position of the object to keep the object in the field of view of the first mirror in response to the first actuator adjusting the position or the orientation of the first mirror to remove the location from the first reflection of the first mirror.

7. The show effect system of claim 1, comprising a display mounted opposite the first mirror and the second mirror, wherein the controller is configured to:
instruct the display to adjust image data to keep imagery on the display in the field of view of the first mirror in response to the first actuator adjusting the position or the orientation of the first mirror to remove the location from the first reflection of the first mirror.

8. The show effect system of claim 1, comprising a projector configured to project image content onto a projection surface opposite the first mirror and the second mirror, wherein the controller is configured to:
generate image data for projection onto an additional wall opposite the wall;
update the image data to updated image data in response to determining the guest is in the location; and
instruct the projector to project the updated image data in parallel with instructing the first actuator to adjust the position or the orientation of the first mirror.

9. The show effect system of claim 1, wherein the sensor is configured to monitor eye blinking of the guest, wherein the controller is configured to:
instruct the first actuator based on eye blinking of the guest.

10. The show effect system of claim 1, comprising an output device configured to emit a visual diversion, an audio diversion, or both, wherein the controller is configured to instruct the output device to emit the visual diversion, the audio diversion, or both prior to instructing the first actuator to adjust the position or the orientation of the first mirror to remove the location from the first reflection of the first mirror.

11. A non-transitory computer-readable medium, comprising instructions that, when executed by one or more processors, are configured to cause the one or more processors to:
receive sensor data from a sensor monitoring guest activity;
determine a position of a guest relative to a show effect system based on the sensor data; and
instruct at least one actuator of the show effect system to adjust a position or an orientation of at least one mirror of the show effect system to adjust a reflection of the at least one mirror to exclude the guest based on the position of the guest.

12. The non-transitory computer-readable medium of claim 11, wherein the instructions, when executed by the one or more processors, are configured to cause the one or more processors to:
instruct a first actuator to adjust a position or the orientation of a first mirror; and
instruct a second actuator to adjust a position or the orientation of a second mirror.

13. The non-transitory computer-readable medium of claim 12, wherein the instructions, when executed by the one or more processors, are configured to cause the one or more processors to:
determine a distance between the guest and the show effect system; and
determine a target angle between the first mirror and the second mirror based on the distance.

14. The non-transitory computer-readable medium of claim 11, wherein the instructions, when executed by the one or more processors, are configured to cause the one or more processors to:
instruct an additional actuator of the show effect system to adjust a position or an orientation of an object of the show effect system based on the reflection of the at least one mirror being adjusted to exclude the guest; or
instruct a display to move imagery based on the reflection of the at least one mirror being adjusted to exclude the guest.

15. The non-transitory computer-readable medium of claim 11, wherein the instructions, when executed by the one or more processors, are configured to cause the one or more processors to initiate a media distraction or detect an eye blink of the guest prior to instructing the at least one actuator of the show effect system to adjust the position or the orientation of the at least one mirror of the show effect system to adjust the reflection of the at least one mirror to exclude the guest based on the position of the guest.

16. An attraction system for an attraction, the attraction system comprising:
a first mirror;
a second mirror;
one or more actuators configured to adjust positioning and/or orientation of the first mirror, the second mirror, or both;
one or more sensors configured to track a position of a guest within the attraction; and
a controller configured to:
receive, from the one or more sensors, sensor data indicative of the position of the guest;
determine a target angle between the first mirror and the second mirror to exclude the position of the guest from a first reflection of the first mirror and/or the second mirror based on the position of the guest; and
instruct the one or more actuators to adjust the positioning and/or the orientation of the first mirror, the second mirror, or both based on the target angle.

17. The attraction system of claim 16, comprising an output device configured to emit a visual effect, an audio effect, or both, wherein the controller is configured to:
instruct the output device to emit the visual effect, the audio effect, or both prior to instructing the one or more actuators to adjust the positioning and/or the orientation of the first mirror, the second mirror, or both based on the target angle.

18. The attraction system of claim 16, wherein the sensor data comprises detected blinking of the guest, and wherein the controller is configured to:
instruct the one or more actuators to adjust the positioning and/or the orientation of the first mirror, the second mirror, or both during a blink of the guest.

19. The attraction system of claim 16, comprising a shutter glasses worn by the guest and configured to temporarily block a view of the guest, wherein the controller is configured to:
determine a shutter timing of the shutter glasses; and
instruct the one or more actuators to adjust the positioning and/or the orientation of the first mirror, the second mirror, or both during a closing period of the shutter glasses.

20. The attraction system of claim 16, wherein the one or more actuators comprise a first actuator coupled to the first mirror and a second actuator coupled to the second mirror.
